(19) United States
(12) Patent Application Publication
(10) Pub. No.: US 2026/0087706 A1
(43) Pub. Date: Mar. 26, 2026

(54) STORAGE MEDIUM, INFORMATION PROCESSING APPARATUS, AND CONTROL METHOD FOR GENERATING PROMPT

(71) Applicant: CANON KABUSHIKI KAISHA, Tokyo (JP)

(72) Inventor: HOSHITO MINAGI, Kanagawa (JP)

(21) Appl. No.: 19/335,993

(22) Filed: Sep. 22, 2025

(30) Foreign Application Priority Data
Sep. 26, 2024 (JP) 2024-167416

(51) Int. Cl. G06T 11/60; H04L 51/02

(52) U.S. Cl. CPC G06T 11/60; G06T 2200/24; H04L 51/02

(57) ABSTRACT

An apparatus and method for executing an add-in program, which is added in an application, that, when executed by a computer, causes the computer to perform a control method for an information processing apparatus, the control method including acquiring information representing at least one of object information about a first object selected by a user in an operation screen of the application and area information about an area selected by the user in the operation screen of the application, acquiring an operation request input by the user, generating a prompt for causing generation of a second object based on the acquired information and the acquired operation request, and transmitting the generated prompt to a server which generates the second object.

### BACKGROUND

### Field of the Technology

The present disclosure relates to an add-in program for generating a prompt and transmitting the generated prompt to a generative artificial intelligence (AI).

### Description of the Related Art

A system for easily creating presentation materials is known. Japanese Patent Laid-Open No. 2023-110936 describes a technique which generates an appropriate slide by narrowing a design candidates prepared based on input text or information about, for example, the age and gender of the user and reflecting the text in the design.

Moreover, there is an increase in the number of AI assistant tools which support the creation of presentation materials using generative AI. For example, in Microsoft PowerPoint^{®} developed by Microsoft, if the user asks Copilot, which is an AI assistant, in natural language: “Please add a slide about the history of women's soccer.”, the slide is created and added.

While the technique described in Japanese Patent Laid-Open No. 2023-110936 is capable of editing a slide as intended by the user according to formats of the design candidates by the user changing the content of text or portions of inputting, the number of designs able to be selected is limited. On the other hand, the technique which causes a generative AI (AI assistant) to create a slide based on natural language is capable of creating a slide which is not restricted to predefined designs. Moreover, issuing an instruction to generative AI with natural language has the advantage of being capable of creating a slide by the generative AI performing interpretation even when receiving rough instructions from the user. However, since the generative AI determines the user’s intention, a slide including an object which the user does not intend may be created. At this time, even if the user attempts to instruct the generative AI to change some of a plurality of objects already arranged on the slide, using an instruction in natural language alone results in difficulty in causing the generative AI to identify an object or objects to be changed.

### SUMMARY

According to an aspect of the present disclosure, a control method for an information processing apparatus, the control method includes acquiring information representing at least one of object information about a first object selected by a user in an operation screen of the application and area information about an area selected by the user in the operation screen of the application, acquiring an operation request input by the user, generating a prompt for causing generation of a second object based on the acquired information and the acquired operation request, and transmitting the generated prompt to a server which generates the second object.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a network configuration according to a first embodiment.

FIG. 2 is a diagram illustrating a hardware configuration of a client personal computer (PC).

FIG. 3 is a diagram illustrating a hardware configuration of a generative artificial intelligence (AI) server.

FIG. 4 is a diagram illustrating software configurations according to the first embodiment.

FIG. 5 is a diagram illustrating an example of an operation screen of an application with an add-in program applied thereto.

FIG. 6 is a diagram illustrating an example of the operation screen which is displayed when the user has selected first text included in an object.

FIG. 7 is a diagram illustrating an example of the operation screen which is displayed when the user has selected an area in which no object exits as a first object.

FIG. 8 is a diagram illustrating an example of the operation screen which is displayed in the case of displaying candidates for an operation request.

FIG. 9 is a diagram illustrating an example of the operation screen which is displayed in a case where an AI assistant operation screen does not exist.

FIG. 10 is an example of a sequence diagram illustrating processing operations according to the first embodiment.

FIG. 11 is a flowchart illustrating an example of processing for generating an operation request confirmation statement.

FIG. 12 is a flowchart illustrating an example of processing for generating a prompt.

FIG. 13 is a diagram illustrating an example of object information.

FIG. 14 is a diagram illustrating an example of a prompt which is generated by the add-in program.

### DESCRIPTION OF THE EMBODIMENTS

Various embodiments, features, and aspects of the present disclosure will be described in detail below with reference to the drawings. Furthermore, the following embodiments are not intended to limit the scope of the present disclosure set forth in claims, and not all of the combinations of features described in the embodiments are essential for solutions in the present disclosure.

### First Embodiment

### System Configuration

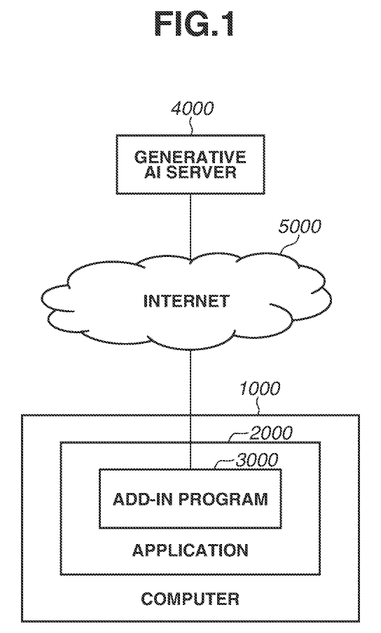

As illustrated in FIG. 1, the network configuration according to a first embodiment includes a computer 1000, which is a terminal device, an application 2000, an add-in program 3000, a generative artificial intelligence (AI) server 4000, and the Internet 5000.

The computer 1000 is arranged, for example, inside an office, and is connected to the Internet 5000, externally arranged, via an in-house network (local area network (LAN): not illustrated) and a router (not illustrated). Here, the computer 1000 is an example of a user terminal (an information processing apparatus which the user uses), and the generative AI server 4000 is an example of an information processing apparatus (server) which provides a generative AI service with use of a large language model (learning model).

Moreover, the application 2000 is an application which runs on the computer 1000, and refers to an application which uses the add-in program 3000 to make an AI assistant function available. The AI assistant function mentioned here refers to a function which accepts an instruction in the form of natural language from the user, communicates with the generative AI server 4000, and generates and outputs an answer using generative AI.

The add-in program 3000 is a program which is added to the application 2000 and is invoked from the application 2000. The add-in program 3000 has the function of communicating with the generative AI server 4000 and providing a product generated by the generative AI server 4000 to the application 2000.

The generative AI server 4000 is in communication with the application 2000 and the add-in program 3000, which are running on the computer 1000, via the Internet 5000 in such a way as to be able to communicate with the application 2000 and the add-in program 3000. The generative AI server 4000 is a server which a business operator providing the add-in program 3000 or a business operator providing a generative AI service manages.

In the first embodiment, the application 2000, the add-in program 3000, and the generative AI server 4000 may be collectively referred to as an “AI assistant system”. Furthermore, respective pieces of hardware which constitute the generative AI server 4000 and the computer 1000 can be separate from each other or can exist on the same hardware as an integral unit. Moreover, the application 2000 can be configured to run on the computer 1000 or can be configured to be implemented as a web application which connects to the computer 1000 via the Internet 5000. In a case where the application 2000 is implemented as a web application, the add-in program 3000 can take the form of being an option which is selectable in the web application.

### Hardware Configuration

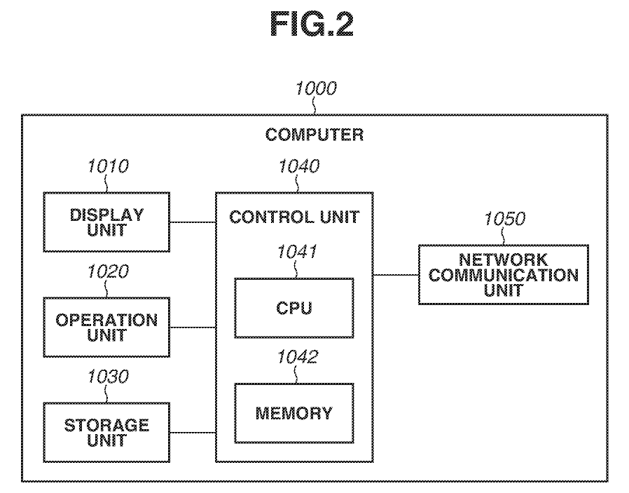

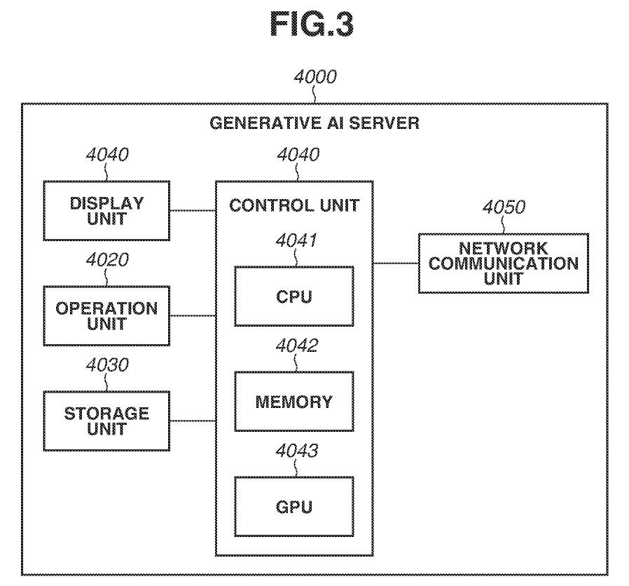

Hardware configurations of the respective devices which constitute the AI assistant system according to the first embodiment are described with reference to FIG. 2 and FIG. 3. FIG. 2 illustrates a hardware configuration of the computer 1000. FIG. 3 illustrates a hardware configuration of the generative AI server 4000.

As illustrated in FIG. 2, the computer 1000 includes a display unit 1010, an operation unit 1020, a storage unit 1030, a control unit 1040, and a network communication unit 1050, and these units are interconnected in such a way as to be able to communicate with each other. The type of the computer 1000 is not particularly limited, and, for example, a desktop-type or notebook-type personal computer, a tablet terminal, or a smartphone can be applied as the computer 1000. The control unit 1040 includes a central processing unit (CPU) 1041 and a memory 1042, and controls the entire computer 1000.

The display unit 1010 includes, for example, a display such as a liquid crystal panel, and is able to display, for example, an image. The operation unit 1020 includes, for example, a mouse and a keyboard, and is able to accept an input operation performed by the user. The storage unit 1030 includes, for example, a storage medium such as a hard disk drive or a solid state drive (SSD), and stores various programs (software) required for the computer 1000 to operate. The programs are loaded onto the memory 1042 as needed and are then executed by the CPU 1041. The programs also include the application 2000 and the add-in program 3000. The CPU 1041 executes the various programs to implement various functions described below. Furthermore, the programs are not limited to those currently stored in the computer 1000. For example, the programs can be stored in each of the computer 1000 and the generative AI server 4000, or can be dispersedly stored in the computer 1000 and the generative AI server 4000. The network communication unit 1050 performs inputting and outputting of data with respect to an external device via an external network.

As illustrated in FIG. 3, the generative AI server 4000 includes a display unit 4010, an operation unit 4020, a storage unit 4030, a control unit 4040, and a network communication unit 4050, and these units are interconnected in such a way as to be able to communicate with each other. The control unit 4040 is configured to include a CPU 4041, a memory 4042, and a graphics processing unit (GPU) 4043, and controls the entire generative AI server 4000. As mentioned above, the hardware configuration of the generative AI server 4000 is almost similar to the hardware configuration of the computer 1000, and, therefore, the detailed description thereof is omitted here.

### Software Configuration

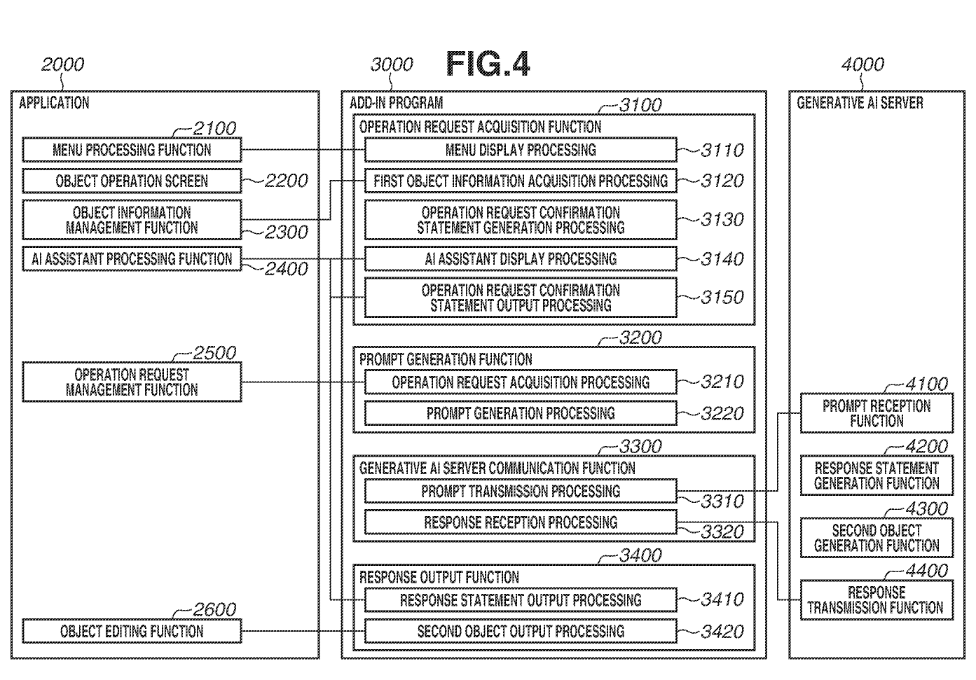

Software configurations of the respective devices which constitute the AI assistant system according to the first embodiment are described with reference to FIG. 4.

As illustrated in FIG. 4, the add-in program 3000 is a program for providing an operation request acquisition function 3100, a prompt generation function 3200, a generative AI server communication function 3300, and a response output function 3400 to the application 2000.

The application 2000 is, for example, presentation software, which arranges, on an object operation screen 2200, objects such as graphics, photos, tables, or text boxes based on the user’s instruction and thus creates a slide for presentation. An object information management function 2300 stores and manages information about objects which are arranged. A menu processing function 2100 displays a pop-up menu in response to the right-click operation of the mouse being performed when a mouse cursor is present on the object operation screen 2200. At this time, in a case where the add-in program 3000 is previously added in the application 2000, the menu processing function 2100 additionally displays options for using an AI assistant in the pop-up menu. Furthermore, an operation for causing the pop-up menu to be displayed is not limited to the right-click operation of the mouse, and, for example, in the case of, for example, a touch panel, a configuration in which, when the selected object has been long-pressed (subjected to a touch and hold operation), the pop-up menu is displayed can be employed. An AI assistant processing function 2400 displays, for example, an AI assistant operation screen, accepts inputting of an operation request from the user with respect to the AI assistant, and displays a response received from the AI assistant. An operation request management function 2500 retains an operation request input by the user and then passes the retained operation request to the prompt generation function 3200 of the add-in program 3000. An object editing function 2600, for example, receives an object generated by the generative AI server 4000 via the add-in program 3000 and then outputs the received object to the inside of a designated area in the object operation screen. Furthermore, the application 2000 serving as a target for application of the add-in program 3000 is not limited to presentation software. For example, the application 2000 can be document creation software or design editing software, and ca be applied to all of the applications equipped with an AI assistant processing function which is able to cooperate with the add-in program 3000.

### Operation Request Acquisition Function

The operation request acquisition function 3100 includes menu display processing 3110, first object information acquisition processing 3120, operation request confirmation statement generation processing 3130, AI assistant display processing 3140, and operation request confirmation statement output processing 3150. In the first embodiment, the operation request refers to a statement representing processing which the user wants to be performed with use of the AI assistant system based on an object (or an area) which the user has selected, such as “please revise the selected object into bullet points”.

The menu display processing 3110 provides the function of displaying a menu according to the first embodiment to the menu processing function 2100 of the application 2000. The menu is a pop-up menu which is displayed in a case where the user has performed a right-click operation on the mouse in the state of selecting an object or area on the object operation screen 2200. In the first embodiment, a configuration in which an option for using an AI assistant is provided within the pop-up menu and the user selects the option to launch the AI assistant, thus making the AI assistant available, is employed. Furthermore, the object refers to a thing which is displayed on the object operation screen 2200, such as a graphic, photo, table, or text box arranged on the object operation screen 2200. Moreover, the user can select, as an object, a character string arranged in an optional range within the text box which is displayed on the object operation screen 2200. Additionally, in the first embodiment, a configuration in which the user is allowed to select, instead of an object such as a graphic, photo, table, or text box, an optional area (an area which is specified by designating a coordinate position on the screen) on the object operation screen 2200 to enable invoking the menu display processing 3110 is also employed. Moreover, for example, a configuration in which the user is allowed to select a slide in a presentation system or a non-object such as a layer in design editing software can also be employed.

The first object information acquisition processing 3120 provides the function of acquiring, from the object information management function 2300, object information concerning an object which the user has previously selected when an instruction for using the AI assistant has been selected by the user from the pop-up menu displayed by the menu display processing 3110. In the following description, the object which the user has previously selected in the object operation screen 2200 is referred to as a “first object”, and an object which has been newly generated in the generative AI server 4000 is referred to a “second object”.

Furthermore, a configuration in which the user is allowed to select a plurality of objects as the first object can be employed. Moreover, the object information refers to information which is used to process an object in the application 2000, such as an identification (ID), type, size, coordinates, or file path of an object which the user has selected. Moreover, the first object information acquisition processing 3120 can acquire, in combination with the object information, text included in the first object. The text mentioned here is expressed by a set of text content and text information. Among these, the text information is information including decorative information such as the language setting, size, inflation setting, color, or indent of text, and the text content refers to the content (i.e., a character string) itself of written text.

The operation request confirmation statement generation processing 3130 provides the function of generating an operation request confirmation statement when an instruction for using the AI assistant has been issued by the user via the pop-up menu. For example, the operation request confirmation statement refers to a statement aimed at confirming processing which the user wants to perform through the use of the AI assistant with respect to an object which the user has selected, such as “Please let me know about processing which you want to perform with respect to this object.”. The operation request confirmation statement can be a fixed phrase which has been preliminarily prepared in the AI assistant system or can be a statement which is changed according to object information or area information acquired in the first object information acquisition processing 3120. Moreover, the operation request confirmation statement generation processing 3130 can generate an operation request confirmation statement with use of the generative AI server 4000 and, at that time, can refer to log information retained by the AI assistant processing function 2400.

The AI assistant display processing 3140 provides the function of, with use of the AI assistant processing function 2400, causing an AI assistant operation screen to be displayed when an instruction for using the AI assistant has been issued by the user via the pop-up menu. Furthermore, the AI assistant operation screen can be displayed within the object operation screen 2200 or can be displayed in such a way as to allow a different window to be popped up. Furthermore, in a case where the AI assistant operation screen is already opened and information about, for example, the already executed operation request is remaining in the AI assistant operation screen, the AI assistant display processing 3140 can perform processing for initializing the information about, for example, the already executed operation request and causing a new AI assistant operation screen to be displayed instead of the already opened AI assistant operation screen.

The operation request confirmation statement output processing 3150 provides the function of outputting an operation request confirmation statement generated by the operation request confirmation statement generation processing 3130 onto the AI assistant operation screen with use of the AI assistant processing function 2400 when an instruction for using the AI assistant has been issued by the user via the pop-up menu.

### Prompt Generation Function

The prompt generation function 3200 includes operation request acquisition processing 3210 and prompt generation processing 3220.

The operation request acquisition processing 3210 provides the function of acquiring, from the operation request management function 2500, an operation request input by the user in the AI assistant operation screen.

The prompt generation processing 3220 provides the function of generating a prompt which is to be input to the generative AI server 4000, based on object information or area information acquired by the first object information acquisition processing 3120 and the operation request acquired by the operation request acquisition processing 3210. The prompt which is generated in the first embodiment is a statement generated from a combination of information for identifying the selected object or area and the operation request. For example, in a case where an object for “text box of object ID = 1” has been selected by the user and an instruction for “Please revise the selected object into bullet points.” has been input as an operation request, the prompt generation processing 3220 combines the selected object and the input operation request and thus generates a prompt indicating “Please revise [text included in the text box of object ID = 1] into bullet points”. Particularly, in the case of generative AI which handles a large language model, since, depending on how to give instructions, a big difference may be made in the accuracy of an answer to be generated, it becomes important how to input a prompt which is readily understood by the generative AI. Therefore, for example, the prompt generation processing 3220 can be configured to, when generating a prompt, shape the prompt into a format which is readily understood by generative AI, such as Markdown format. Alternatively, the prompt generation processing 3220 can be configured to, when generating a prompt, add factors other than object information and an operation request, such as a policy of processing which generative AI performs, an output method, and line boundary character check (Japanese hyphenation) particulars.

Moreover, the prompt generation processing 3220 can be configured to be able to refer to an image file which is not arranged in the object operation screen to generate a prompt for causing the generative AI server 4000 to generate content. For example, suppose that the user has selected an area on the object operation screen and an operation request indicating, for example, “Please recreate the image from a separate file with a brighter atmosphere and arrange the recreated file in the selected area.” has been input by the user to the AI assistant. In this case, since it is necessary to refer to the separate file different from an object already arranged on the object operation screen, the prompt generation processing 3220 only needs to cause, via the operation request confirmation statement output processing 3150, a user interface and a message for causing the user to designate the separate file to be displayed in the screen. Then, the prompt generation processing 3220 only needs to pass the generated prompt and the separate file designated via the user interface to prompt transmission processing 3310 of the generative AI server communication function 3300 and cause the prompt transmission processing 3310 to transmit them to the generative AI server 4000.

### Generative AI Server Communication Function

The generative AI server communication function 3300 includes prompt transmission processing 3310 and response reception processing 3320.

The prompt transmission processing 3310 provides the function of transmitting the prompt generated by the prompt generation processing 3220 to a prompt reception function 4100 of the generative AI server 4000, thus making a content generation request to the generative AI server 4000.

A response statement generation function 4200 and a second object generation function 4300 included in the generative AI server 4000 interpret the prompt received by the prompt reception function 4100 and then generate a response statement and a second object, respectively. Then, a response transmission function 4400 transmits the response statement generated by the response statement generation function 4200 and the second object generated by the second object generation function 4300 to the response reception processing 3320 of the add-in program 3000.

The response reception processing 3320 of the add-in program 3000 provides the function of receiving a response including, for example, the response statement and second object generated in the generative AI server 4000. The response mentioned here can include, for example, two types of contents, i.e., a response statement which is displayed in the AI assistant operation screen such as “I’ve revised the selected object into bullet points.” and a second object which is displayed in the object operation screen 2200. Alternatively, the response mentioned here can be, for example, parameters required for acquiring a file content including the second object, such as a link to a storage having stored a file of the second object generated in the generative AI server 4000. Furthermore, the second object which is generated in the generative AI server 4000 is not limited to an image or text but can be, for example, a code or macro. In that case, for example, the code or macro received in the response reception processing 3320 can be embedded in a presentation which is in the process of being created in the application 2000.

### Response Output Function

The response output function 3400 includes response statement output processing 3410 and second object output processing 3420.

The response statement output processing 3410 provides the function of displaying a response statement received from the generative AI server 4000 by the response reception processing 3320 on the AI assistant operation screen via the AI assistant processing function 2400.

The second object output processing 3420 provides the function of outputting a second object received from the generative AI server 4000 by the response reception processing 3320 to the object editing function 2600 of the application 2000 and thus outputting the second object to the inside of the designated area of the object operation screen. Alternatively, the second object output processing 3420 can be configured to once display a second object received from the generative AI server 4000 by the response reception processing 3320 on the AI assistant operation screen and cause the user to confirm the second object. In that case, in response to an instruction for applying the second object confirmed by the user being issued, the second object output processing 3420 can paste the second object to the designated position in the object operation screen. Moreover, in a case where a link to the storage has been previously received by the response reception processing 3320, the second object output processing 3420 can provide the function of acquiring a second object from the received link destination and outputting the acquired second object to the application 2000. Moreover, for example, in a case where a second object in tubular form has been generated in response to a prompt that is based on an operation request indicating, for example, “Please convert the content of this text box into tubular form.”, the second object output processing 3420 can cause the object editing function 2600 to replace the text box (first object) with a second object in tubular form and thus directly update object information which the object information management function 2300 manages.

Thus far is the description of software configurations of the respective devices constituting the AI assistant system according to the first embodiment.

### Example of Operation Screen

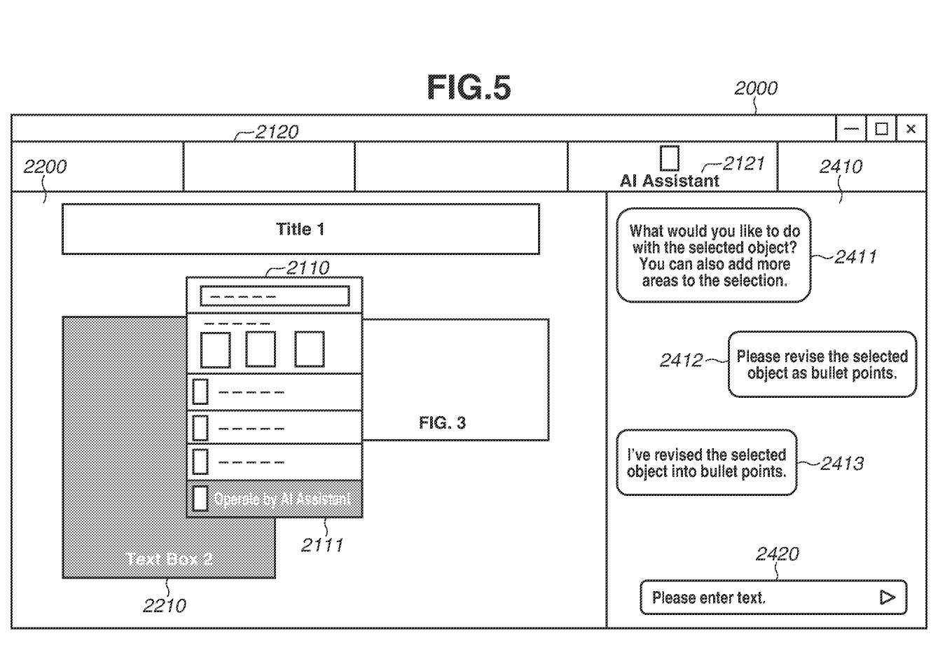

An example of an operation screen which the add-in program 3000 provides to the application 2000 according to the first embodiment is described with reference to FIG. 5.

In an object operation screen 2200 which is displayed by the application 2000, for example, in a case where, in a state in which a first object 2210 has been selected by the user operation, a right-click operation of the mouse has been performed, a pop-up menu (menu field) 2110 is displayed. At this time, the add-in program 3000 performs control in such a manner that an option (menu 2111) for using the AI assistant is displayed in the menu field 2110. Additionally, the add-in program 3000 is assumed to also provide a menu button 2121 for invoking the AI assistant, on a menu bar 2120 which is displayed by the application 2000. Thus, the user is also able to invoke the AI assistant by, instead of performing an operation for designating the option 2111 from the pop-up menu displayed by right-clicking on the selected object, performing an operation for designating the menu button 2121 after selecting the object 2210.

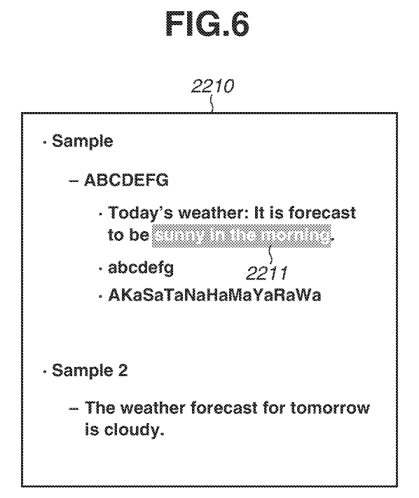

Furthermore, while, in the example illustrated in FIG. 5, “Text Box 2” is currently selected as the first object 2210, the selection target is not limited to “text box”, but can be a text box for “Title 1” or an object such as a drawing for “FIG. 3”. Furthermore, while, in FIG. 5, each object is simply displayed as a rectangle, actually, for example, a character string or graphic is assumed to be displayed. Moreover, while, in the example illustrated in FIG. 5, the entire text box is currently selected as the first object, the first embodiment is not limited to this example, and a configuration in which a character string in part of the text box is selectable as the first object can be employed. For example, when, as illustrated in FIG. 6, text is included in the text box 2210, a configuration in which the user selects, as the first object, an optional character string portion 2211 included in the text can be employed.

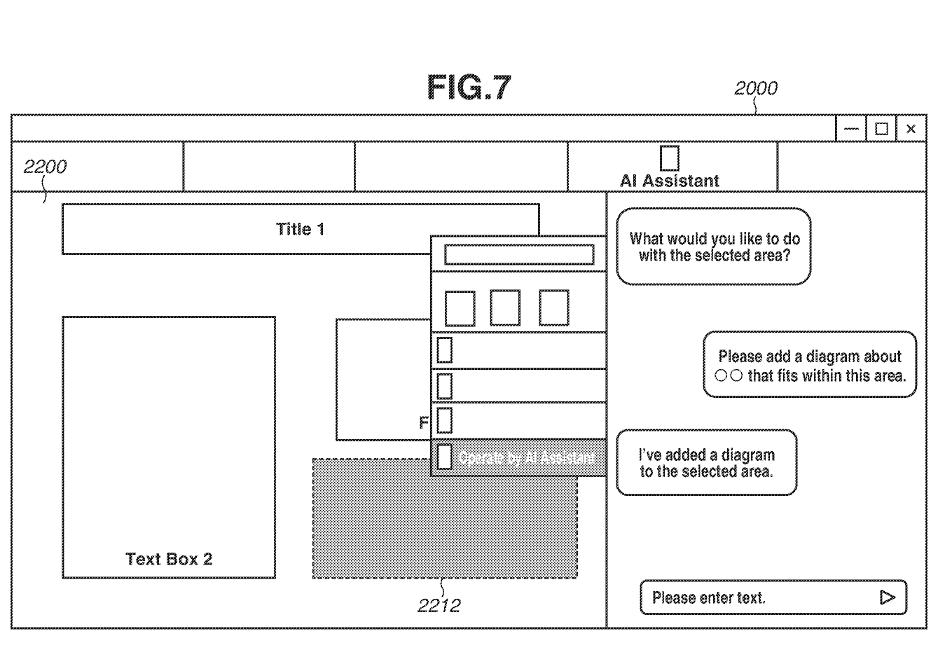

Moreover, in a case where, as illustrated in FIG. 7, the user selects an optional area 2212 on the object operation screen 2200 to cause a pop-up menu to be displayed, the user only needs to designate the rectangular area 2212 with use of, for example, the mouse and right-click on the area 2212 with the mouse. In that case, the prompt generation processing 3220 generates a prompt based on, in addition to an operation request, information about, for example, the coordinates or size of the selected area (hereinafter referred to as “area information”).

Then, as illustrated in FIG. 5, in a case where the menu 2111 or the menu button 2121 has been executed by the user, the add-in program 3000 launches an AI assistant operation screen 2410 and outputs an operation request confirmation statement 2411 to the AI assistant operation screen 2410. At this time, in the operation request confirmation statement 2411, as described below, a message associated with the previously selected object or area comes to be displayed. Then, when the user inputs an operation request to an AI assistant entry field 2420 and then presses, for example, a return key for confirmation, the add-in program 3000 displays the input operation request 2412 in the AI assistant operation screen 2410. Then, the add-in program 3000 generates a prompt based on the input operation request and information about the selected object or area, and transmits the generated prompt to the generative AI server 4000.

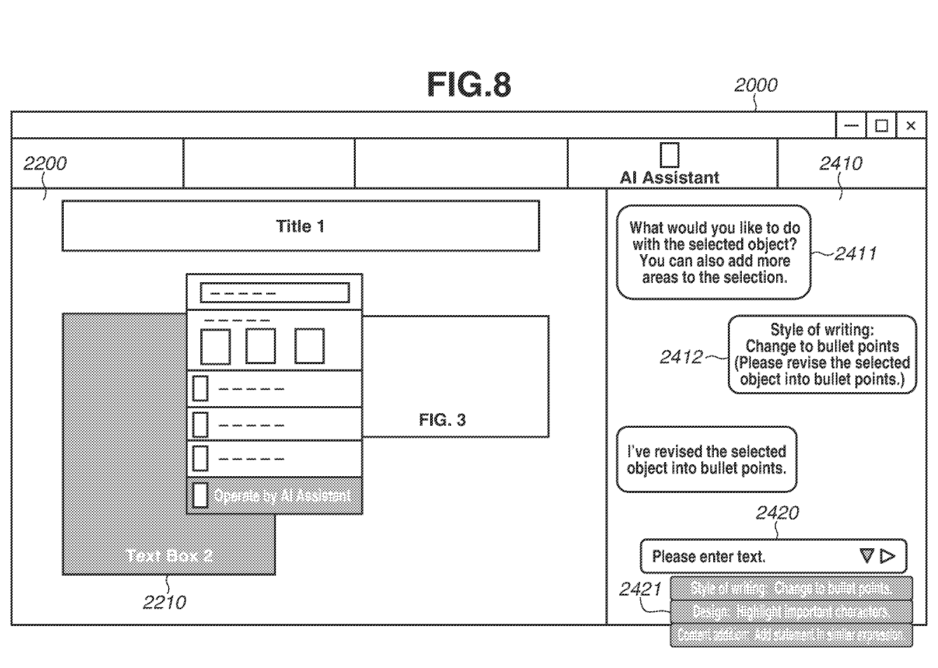

Furthermore, a configuration in which, as illustrated in FIG. 8, when displaying the operation request confirmation statement 2411 in the AI assistant operation screen 2410, the add-in program 3000 displays, in list form, options 2421 for an operation request according to the type of the first object 2210 which the user has selected can be employed. Then, the add-in program 3000 can input a candidate selected by the user from among the options displayed in list form as an operation request to the entry field 2420. In that case, the content of the operation request 2412 which is displayed in the AI assistant operation screen 2410 can be just the description displayed in the options 2421, or can be the content including the more detailed description as illustrated in FIG. 8 (the content to which a description shown in parentheses has been applied as the operation request 2412 illustrated in FIG. 8). Furthermore, a configuration in which options for an operation request are preliminarily prepared by the add-in program 3000 and, among the prepared options, options associated with the type of the selected object or the type of the selected area are displayed can be employed.

The add-in program 3000 transmits a prompt to the generative AI server 4000 and then receives a response from the generative AI server 4000. The response which is received from the generative AI server 4000 includes, for example, a second object or response statement generated in the generative AI server 4000 based on the prompt. Upon receiving the response from the generative AI server 4000, the add-in program 3000 outputs a response statement 2413 to the AI assistant operation screen 2410, and updates the first object 2210 with a second object which the second object generation function 4300 has generated.

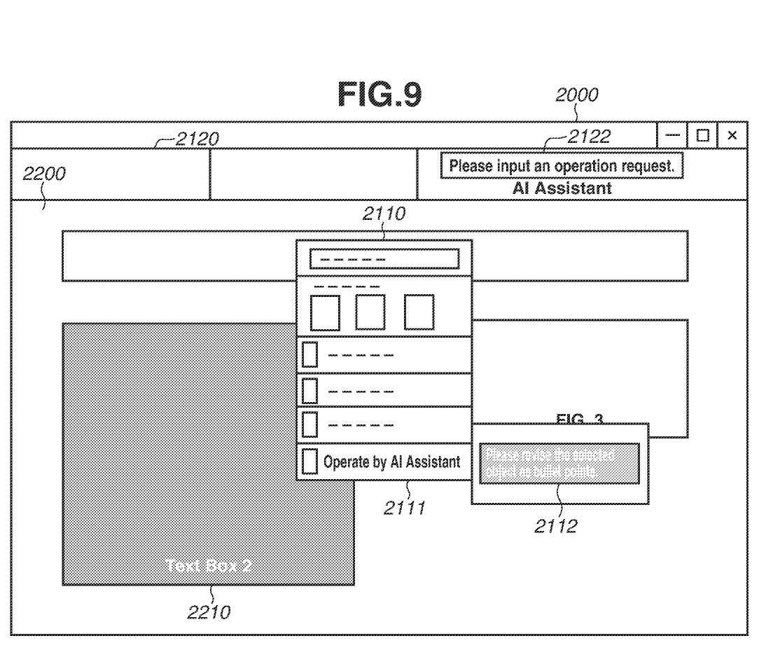

Moreover, in the case of an application 2000 in which an area for the AI assistant operation screen 2410 such as that illustrated in FIG. 5 is not provided, an example of an operation screen which is displayed when the add-in program 3000 provides an AI assistant function is described with reference to FIG. 9. Even in FIG. 9, when, in a state in which the first object 2210 is currently selected on the object operation screen 2200, in response to the right-click operation of the mouse on the first object 2210, the add-in program 3000 causes a pop-up menu (menu field) 2110 to be displayed, the menu 2111 is displayed. Additionally, when the user points the mouse cursor onto the menu 2111, an operation request input field 2112 comes to be displayed. The operation request input field 2112 has a function similar to that of the AI assistant entry field 2420 illustrated in FIG. 5 and allows an operation request to be input thereto by the user. Moreover, the add-in program 3000 can be configured to provide an operation request input button 2122 on the menu bar 2120. The operation request input button 2122 has also a function similar to that of the AI assistant entry field 2420 and allows an operation request to be input thereto by the user.

### Sequence

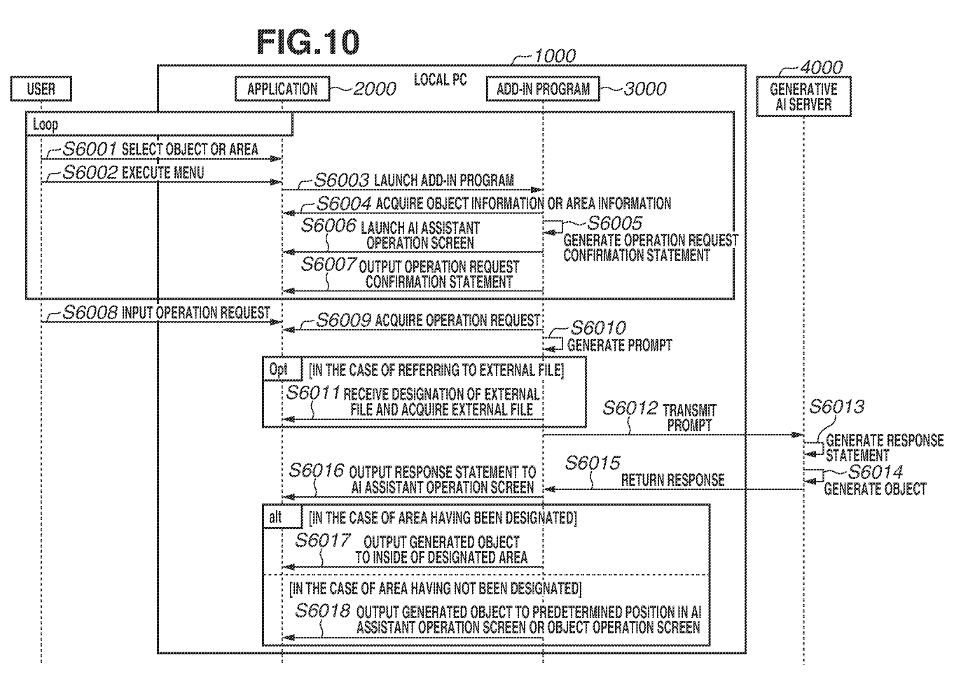

A sequence for the AI assistant system which is performed between the user, the application 2000, the add-in program 3000, and the generative AI server 4000 in the first embodiment is described with reference to FIG. 10.

First, in step S6001, the application 2000 changes an object or area into a selected state according to a selection operation performed by the user. The selected state mentioned here is a status to which the object or area transitions when, for example, the user has clicked on the object or area on the object operation screen 2200, and, for example, an object in the selected state is changed in the background color thereof to enable the user to recognize that the object is in the selected state. Moreover, in the case of selecting an area, the user can change the area into a selected state by designating, on the object operation screen, upper left coordinates and lower right coordinates of the desired area with use of, for example, a mouse pointer.

Next, in step S6002, as described with reference to FIG. 5, in response to a right click operation of the mouse being performed by the user on the object or area which is in the selected state, the application 2000 displays a pop-up menu. Then, upon detecting that the execution of a menu for “operate by the AI assistant” has been selected by the user from the displayed pop-up menu, in step S6003, the application 2000 launches the add-in program 3000. Furthermore, while a processing operation in step S6003 conforms to specifications set in the application 2000, if the add-in program 3000 has been already launched, the application 2000 only needs to notify the add-in program 3000 that the add-in program 3000 has been invoked.

In step S6004, the add-in program 3000 acquires, from the application 2000, object information about a first object which is in the selected state or area information about an area which is in the selected state.

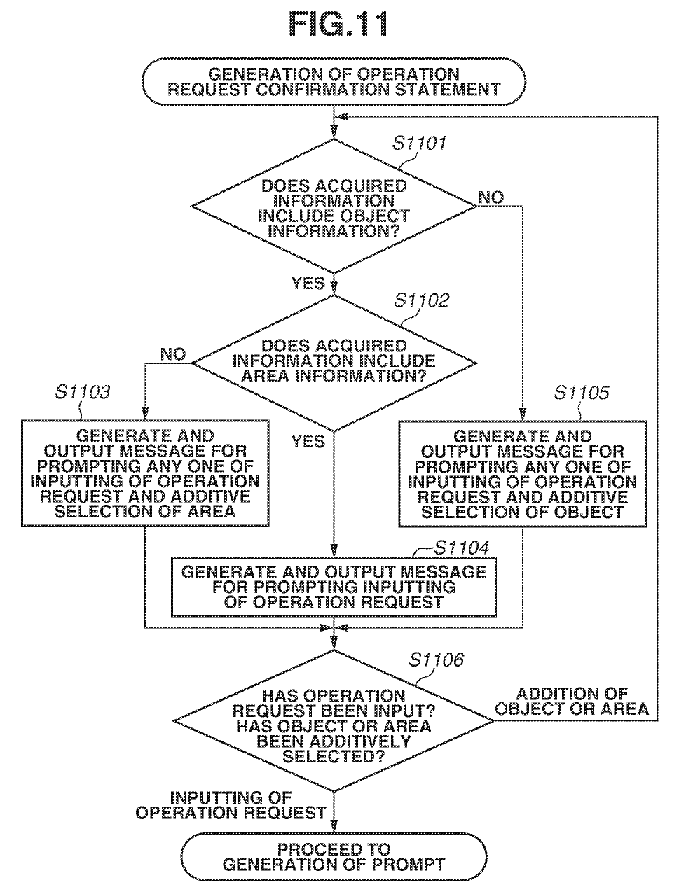

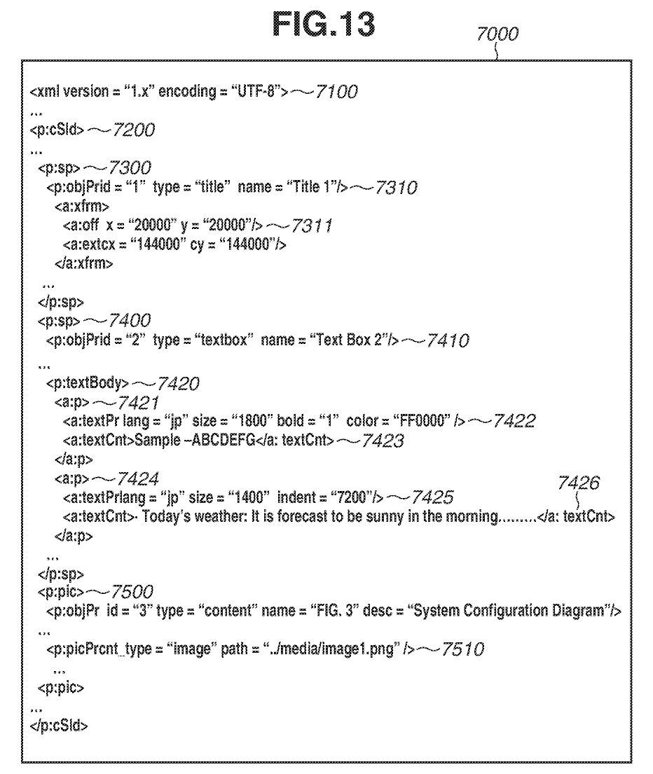

In step S6005, the add-in program 3000 generates an operation request confirmation statement. It is favorable that the operation request confirmation statement is generated as a statement associated with an object or area which is in the selected state. The details of processing for generating an operation request confirmation statement are described below with reference to FIG. 11. Moreover, while a specific example of object information which is acquired in step S6004 is described below with reference to FIG. 13, the operation request confirmation statement can be a fixed phrase. Alternatively, for example, a statement illustrating by an example an executable operation previously set based on the type of the first object, such as “What would you like to do with this text box? For example, you can highlight important text, revise the text into bullet points, or summarize the text.”, can be added to the operation request confirmation statement.

In step S6006, the add-in program 3000 instructs the application 2000 to launch the AI assistant operation screen. For example, the add-in program 3000 causes an area for issuing an instruction to the AI assistant in a chat format (the AI assistant operation screen 2410) to be displayed in a window which is displayed by the application 2000, as illustrated in FIG. 5. Furthermore, the AI assistant operation screen 2410 is not limited to a screen which is caused to be displayed in a window of the application 2000, but can be a screen which is displayed as a separate window. Furthermore, if the AI assistant operation screen 2410 has been already launched, a processing operation in step S6006 can be skipped.

In step S6007, the add-in program 3000 outputs the operation request confirmation statement to the AI assistant operation screen 2410 which is currently displayed by the application 2000, thus causing the operation request confirmation statement to be displayed in the AI assistant operation screen 2410.

Furthermore, the above-mentioned processing operations in step S6004, step S6006, and step S6007 are merely examples, and how to exchange information in the respective processing operations can be modified as needed according to specifications set in the application 2000.

There is a case where, after the processing operation in step S6007, no operation request is input by the user, a new separate object or separate area is brought into the selected state by the user, and an instruction for “operate by the AI assistant” is issued via the pop-up menu. In that case, while keeping the previously acquired object information or area information, the add-in program 3000 additionally acquires object information about the new separate object brought into the selected state or area information about the new separate area brought into the selected state. In this case, the processing operations in step S6001 to step S6007 are repeatedly performed.

In step S6008, the application 2000 accepts inputting of an operation request performed by the user. Next, in step S6009, the add-in program 3000 acquires the input operation request from the application 2000.

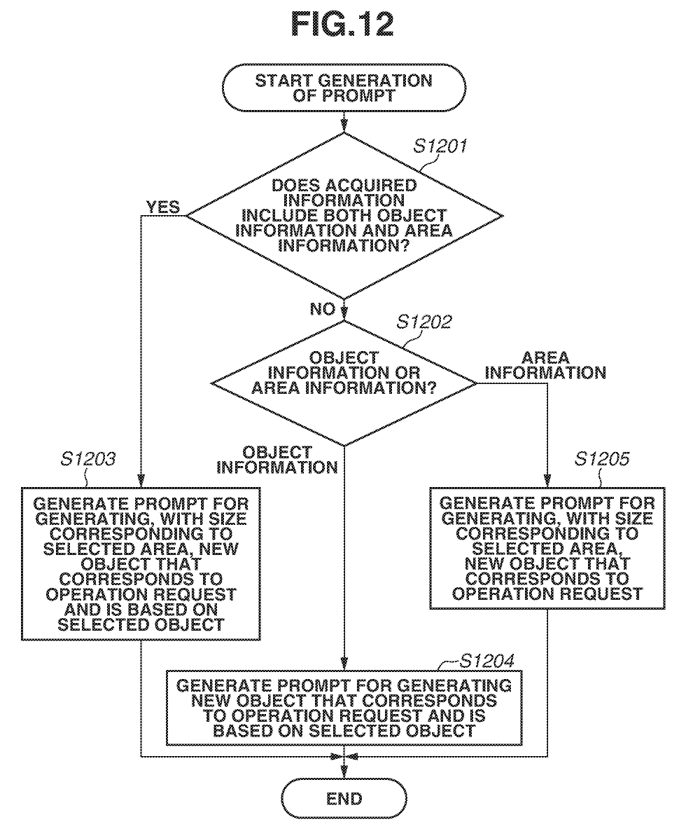

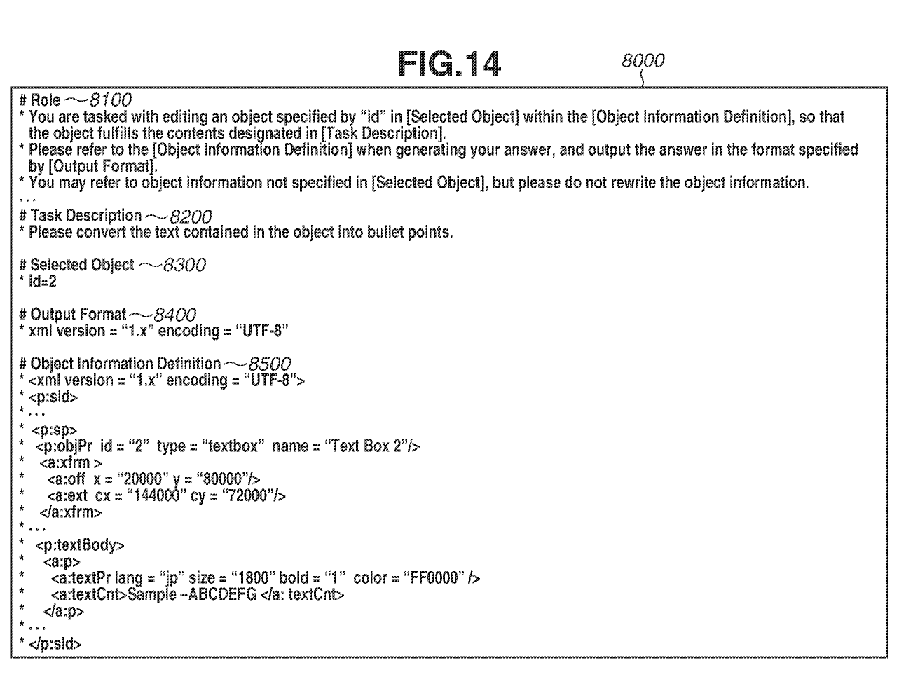

Then, in step S6010, the add-in program 3000 generates a prompt for issuing an instruction to the generative AI server 4000, based on the operation request acquired in step S6009 and the object information about the first object or area information acquired in step S6004. The details of generation of the prompt are described below with reference to FIG. 12. Moreover, a specific example of the prompt which is generated in step S6010 is described below with reference to FIG. 14.

Furthermore, there is a case where, when analyzing the operation request to generate a prompt, the add-in program 3000 determines that a request for referring to an external file has been issued by the user. In that case, in step S6011, the add-in program 3000 requests the application 2000 to display a screen for designating an external file serving as a reference target and thus acquires information about the external file designated by the user via the displayed screen.

In step S6012, the add-in program 3000 transmits the generated prompt to the generative AI server 4000. The prompt which is transmitted to the generative AI server 4000 also includes, for example, the object information or area information acquired in step S6004 and the information about an external file acquired in step S6011. Furthermore, the detailed communication procedure at the time of transmission of the prompt in step S6012 can be modified as needed according to specifications set in the generative AI server 4000 serving as a transmission destination.

The generative AI server 4000, having received the prompt, inputs the received prompt to a learning model (generative AI) and thus performs generation of a response statement in step S6013 and generation of a new object (second object) in step S6014. Then, in step S6015, the generative AI server 4000 returns, to the add-in program 3000, the generated response statement and the generated second object as a response to the prompt.

In step S6016, the add-in program 3000 outputs the response statement included in the response received in step S6015 to the AI assistant operation screen of the application 2000.

Moreover, in a case where area information has been included in the information acquired in step S6004 (i.e., an area has been designated by the user), the prompt which is generated in step S6010 includes an instruction for generating a new object associated with the size of the area information. Accordingly, the new object (second object) generated by the generative AI server 4000 in step S6014 is an object made suitable for the area. Therefore, in step S6017, the add-in program 3000 outputs the second object to the designated area in the object operation screen and causes the second object to be displayed in that area.

Moreover, in a case where area information has not been included in the information acquired in step S6004 (i.e., no area has been designated by the user and only the first object has been selected by the user), the prompt which is generated in step S6010 includes no area information. Accordingly, the new object (second object) generated by the generative AI server 4000 in step S6014 is an object that is based on object information about the first object and is, therefore, an object generated based on the size, type, or object content of the first object. Therefore, in step S6018, the add-in program 3000 outputs the second object to the AI assistant operation screen and causes the second object to be displayed in the AI assistant operation screen. Then, the add-in program 3000 causes the user to select, via the AI assistant operation screen, whether to arrange the second object by replacing the first object in the object operation screen with the second object or whether to arrange the second object by adding the second object to the object operation screen. Furthermore, in a case where the application 2000 does not have the function of displaying the AI assistant operation screen, the add-in program 3000 can cause the second object to be displayed in a predetermined position (for example, a central portion) in the object operation screen. In step S6018, the add-in program 3000 can determine, as needed according to, for example, specifications set in the application 2000, whether to display the second object in the AI assistant operation screen or whether to display the second object in the object operation screen.

Finally, while the sequence illustrated in FIG. 10 once ends with the above-described processing, in a case where there is another operation request with respect to the user, a similar sequence is performed again starting with step S6001. In that case, a configuration in which, when generating a prompt in step S6010, the add-in program 3000 is able to acquire a previous chat log from the AI assistant processing function 2400 and additionally write the acquired previous chat log to the prompt can be employed. The chat log mentioned here is a combination of, for example, operation request information which the user previously input, object information about a first object or area information which the user previously selected, and object information about the generated second object. Moreover, a configuration in which the add-in program 3000 is able to convert object information about the generated second object into an image format and preliminarily store the converted second object and then invoke the preliminarily stored second object based on a user’s instruction at optional timing can be employed.

The details of generation processing and output processing for an operation request confirmation statement in step S6005 to step S6007 are described with reference to FIG. 11. Furthermore, the processing illustrated in FIG. 11 is merely an example, and is not limited to such a procedure.

In step S1101, the add-in program 3000 determines whether the information acquired in step S6004 includes object information. Furthermore, in a case where the processing operations in step S6001 to step S6007 have been repeatedly performed, since a plurality of pieces of information has already been acquired via step S6004, the add-in program 3000 determines whether object information is included in the plurality of pieces of information.

Moreover, in step S1102, the add-in program 3000 determines whether the information acquired in step S6004 includes area information.

If, as a result of determinations in step S1101 and step S1102, it is determined that the acquired information includes object information but does not include area information (YES in step S1101 and NO in step S1102), then in step S1103, the add-in program 3000 generates “a message for prompting any one of inputting of an operation request and additive selection of an area” and then outputs the generated message to the application 2000.

If, as a result of determinations in step S1101 and step S1102, it is determined that the acquired information includes both object information and area information (YES in step S1101 and YES in step S1102), then in step S1104, the add-in program 3000 generates “a message for prompting inputting of an operation request” and then outputs the generated message to the application 2000.

If, as a result of determinations in step S1101 and step S1102, it is determined that the acquired information does not include object information (and includes area information) (NO in step S1101), then in step S1105, the add-in program 3000 generates “a message for prompting any one of inputting of an operation request and additive selection of an object” and then outputs the generated message to the application 2000.

Furthermore, while, in step S1104, only a message for prompting inputting of an operation request is displayed, the message is not confined to only inputting of an operation request and whether the user inputs an operation request at this point of time is left to the user’s discretion. Accordingly, in step S1106, the add-in program 3000 determines whether an operation request has been input by the user or whether an object or area has been additively selected by the user. Then, in a case where inputting of an operation request has been performed (INPUTTING OF OPERATION REQUEST in step S1106), then in step S6009 and step S6010, the add-in program 3000 performs acquisition of an operation request and generation of a prompt. Moreover, in a case where, without inputting an operation request, the user has additively selected an object or area (ADDITION OF OBJECT OR AREA in step S1106), the add-in program 3000 performs the processing operations in step S6001 to step S6007 again, so that the processing illustrated in FIG. 11 is also performed again.

Next, the details of generation processing for a prompt in step S6010 are described with reference to FIG. 12.

Furthermore, the processing illustrated in FIG. 12 is merely an example, and is not limited to such a procedure.

In step S1201, the add-in program 3000 determines whether the information acquired in step S6004 includes both object information and area information, and, if it is determined that the information includes both (YES in step S1201), the add-in program 3000 advances the processing to step S1203 and, if it is determined that the information does not include both (NO in step S1201), the add-in program 3000 advances the processing to step S1202.

In step S1202, the add-in program 3000 determines whether the information acquired in step S6004 is only object information or only area information, and, if it is determine that the information is object information (OBJECT INFORMATION in step S1202), the add-in program 3000 advances the processing to step S1204 and, if it is determine that the information is area information (AREA INFORMATION in step S1202), the add-in program 3000 advances the processing to step S1205.

In step S1203, the add-in program 3000 generates a prompt for generating, with a size corresponding to the area information acquired in step S6004, a second object that is based on the object information about the first object acquired in step S6004 and the content designated by the operation request acquired in step S6009. For example, in a case where the add-in program 3000 has acquired object information for “text box of object ID = 2” illustrated in FIG. 5 and area information for the area 2212 in step S6004 and has further acquired an instruction for “Please convert text into tabular form” as an operation request in step S6009, the add-in program 3000 generates a prompt indicating “Please convert [text included in a text box of object ID = 2] into tabular form in such a way as to fit in [the size of the area 2212]”.

In step S1204, the add-in program 3000 generates a prompt for generating a second object that is based on the object information about the first object acquired in step S6004 and the content designated by the operation request acquired in step S6009. For example, in a case where the add-in program 3000 has acquired object information for “text box of object ID = 2” illustrated in FIG. 5 in step S6004 and has further acquired an instruction for “Please convert text into bullet points” as an operation request in step S6009, the add-in program 3000 generates a prompt indicating “Please convert [text included in a text box of object ID = 2] into bullet points”.

In step S1205, the add-in program 3000 generates a prompt for generating, with a size corresponding to the area information acquired in step S6004, a second object that is based on the content designated by the operation request acquired in step S6009. For example, in a case where the add-in program 3000 has acquired area information about the area 2212 illustrated in FIG. 7 in step S6004 and has further acquired an instruction for “Please create an illustration of a penguin.” as an operation request in step S6009, the add-in program 3000 generates a prompt indicating “Please create an illustration of a penguin with a size fitting into [the size of the area 2212]”.

Furthermore, when generating a prompt in each of step S1203 to step S1205, the add-in program 3000 generates a prompt by analyzing the operation request and combining a result of the analysis and the acquired first object information or area information. Furthermore, analyzing the operation request includes, for example, conducting an analysis such as preliminarily preparing formats of prompts serving as some candidates therefor with respect to an example of an operation request and performing comparison in resemblance with an operation request actually input by the user to determine which format to apply. Furthermore, the method of analyzing an operation request is not limited to this, but can include, for example, causing an external language analysis device to conduct a natural language analysis. Moreover, when conducting an analysis of an operation request, the add-in program 3000 can simultaneously determine whether it is necessary to refer to an external file. If it is determined that it is necessary to refer to an external file, the add-in program 3000 performs the processing operation in step S6011.

### Example of Object Information

An example of object information which the add-in program 3000 according to the first embodiment acquires in the first object information acquisition processing 3120 is described with reference to FIG. 13. For example, an object information definition file 7000 in a case where three objects, i.e., “Title 1”, “Text Box 2” and “FIG. 3”, are displayed as in the object operation screen 2200 illustrated in FIG. 5 includes pieces of information 7100 to 7500. The object information definition file mentioned here is data which is managed in the object information management function 2300, and refers to, for example, a file which is managed in units of a list of objects which are displayed in one slide in a given presentation system. However, the object information does not need to be completed by a single object information definition file 7000, and, for example, the object information can refer to another file in the format of, for example, a link or path. Furthermore, the description shown in FIG. 13 is a description which has been modified in part for the sake of explanation, and thus does not conform to the format of a specific object information definition file which exists in reality.

First, a description 7100 is format information for the object information definition file. The format information includes, as applicable information, for example, versions of the Office Open XML format or the Illustrator format. It is assumed that the second object generation function 4300 in the generative AI server 4000 is configured to be able to generate a second object in a format which enables the second object to be inserted into such a format file.

A range 7200 delimited by tag <p:cSld> in the present example represents a description concerning object information. The range 7200 exits solely within the object information definition file 7000, and, within the range delimited by tag <p:cSld>, object information about each object which is managed with the object information definition file 7000 is described. The following ranges 7300 to 7500 are descriptions concerning pieces of object information about the respective objects described in the object information definition file 7000.

First, the range 7300 delimited by tag <p:sp> in the present example represents the simplest example of object information. A range 7310 delimited by tag <p:objPr> describes object information concerning a target object. This object information includes, in the present example, parameters named as “id” for uniquely identifying the object, “type” meaning the type of the object, and “name” uniquely allocated to the object. While the description method for the range 7310 is not limited to the description in the present example, to enable the generative AI server 4000 to determine which is the first object selected by the user, the description in the range 7310 needs to include at least information uniquely indicating an object. Moreover, a range 7311 delimited by tag <a:xfrm> describes information indicating an area in which the object is displayed on the object operation screen 2200. For example, in the present example, the information indicating such an area is managed by tag <a:off> indicating x coordinate and y coordinate serving as a reference point of an object of the quadrangle type named as “title” and tag <a:ext> indicating the lengths in the x-direction and y-direction of the object. Furthermore, the content of the range 7311 varies depending on the type of an object and is not necessarily managed by tag <a:xfrm>.

The range 7400 delimited by tag <p:sp> in the present example represents an example of a case where an object includes text. First, a range 7410 delimited by tag <p:objPr> describes target object information as with the range 7310. Then, a range 7420 delimited by tag <p:textBody> describes text included in the target object. In the present example, two texts differing in text information described in a range 7421 and a range 7424 each delimited by tag <a:p> are written. The respective texts include pieces of text information described in a range 7422 and a range 7425 each delimited by tag <a:textPr> and text contents described in a range 7423 and a range 7426 each delimited by tag <a:textCnt>. Among these, the text information includes, in the present example, parameters named as “lang” indicating language information, “size” indicating the size of a character, “bold” indicating inflation setting of a character, “color” indicating the color of a character, and “indent” indicating indention of a character. However, there is a case where the text information does not include unique information indicating each text such as “id”. Therefore, in a case where the user designates, instead of an object, text in an optional range included in the object as illustrated in FIG. 6, information for uniquely specifying the first text serving instead of, for example, “id” can be handled in the form of, for example, “from the A-th character to the B-th character in an object of id = 2”.

The range 7500 delimited by tag <p:pic> in the present example represents an example of the case of designating an external file existing outside the object information definition file 7000 such as a still image or a moving image. In the present example, a range 7510 delimited by tag <p:picPr> includes parameters named as “cnt_type” indicating the type of the external file and “path” indicating a file path to the external file.

The above-mentioned contents are merely examples, the description about object information is not limited to the example illustrated in FIG. 13, and there are no limitations concerning formats except that the object information enables acquiring at least information for uniquely specifying an object such as “id”.

### Example of Prompt

An example of a prompt which the add-in program 3000 according to the first embodiment generates in the prompt generation processing 3220 is described with reference to FIG. 14. For example, a prompt 8000 illustrated in FIG. 14 includes pieces of information 8100 to 8500. Furthermore, in the present example, the prompt 8000 is described in Markdown format to increase the recognition accuracy of generative AI, but does not necessarily need to be described in this method.

First, the information 8100 indicates a role which generative AI is wanted to play. The information 8100 describes, for example, the policy of processing which generative AI performs and the contents of, for example, an output method and a line boundary character check item. On this occasion, clearly specifying a designated portion in the prompt with use of a delimiting character such as [ ] is effective for increasing the generation accuracy of generative AI.

The information 8200 describes an operation request which the user has input in the AI assistant operation screen 2410. While the information 8200 can directly describe an operation request which the user has input, for example, the action of summarizing a user’s operation request or extracting important words therefrom with use of generative AI is also effective for increasing the generation accuracy. Furthermore, such an operation can be performed by the add-in program 3000 or can be performed by the generative AI server 4000.

Then, the pieces of information 8300 to 8500 describe object information acquired in the first object information acquisition processing 3120. First, the information 8300 describes information for uniquely identifying the first object. In the information 8300, “id” of the object or a statement such as “from the A-th character to the B-th character in an object of id = 2” is described. The information 8400 describes format information about a file which defines object information acquired in the first object information acquisition processing 3120. Then, the information 8500 describes, for example, the entire content of a file including object information such as that described with reference to FIG. 13. Furthermore, while, in FIG. 14, an example in which the entire content of a processing target file is described has been described, the first embodiment is not limited to this example, and a configuration in which a portion concerning the selected object is described can be employed.

The above-mentioned contents are merely examples, and the prompt 8000 only needs to describe at least object information concerning the first object, including information for uniquely specifying the first object which the user has selected, and a prompt which is generated based on an operation request.

The present disclosure can also be implemented by processing for supplying a program for implementing one or more functions of the above-described embodiments to a system or apparatus via a network or a storage medium and causing one or more processors included in a computer of the system or apparatus to read out and execute the program. Moreover, the present disclosure can also be implemented in combination with a circuit which implements one or more functions of the above-described embodiments (for example, an application specific integrated circuit (ASIC) or a processor dedicated to image processing).

While the embodiments of the present disclosure have been described above, the present disclosure is not limited to these embodiments and can be modified or altered in various manners within the scope of the gist thereof.

According to an aspect of the present disclosure, it is possible to readily generate a prompt for causing a second object to be displayed, based on at least any one of a first object and an area selected by the user on an operation screen of an application.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167416 filed September 26, 2024, which is hereby incorporated by reference herein in its entirety.

What is claimed is:

1. A control method for an information processing apparatus, the control method comprising:
acquiring information representing at least one of object information about a first object selected by a user in an operation screen of the application and area information about an area selected by the user in the operation screen of the application;
acquiring an operation request input by the user;
generating a prompt for causing generation of a second object based on the acquired information and the acquired operation request; and
transmitting the generated prompt to a server which generates the second object.

2. The control method according to claim 1 further comprising:
performing processing specified by the operation request on the object information about the first object based on a size specified by the area information and generating a prompt for issuing an instruction for generation of the second object when both the object information about the first object and the area information are included in the acquired information.

3. The control method according to claim 1 further comprising:
, performing processing specified by the operation request on the object information about the first object and generating a prompt for issuing an instruction for generation of the second object the object information about the first object is included in the acquired information and the area information is not included in the acquired information.

4. The control method according to claim 1 further comprising:
performing processing specified by the operation request based on a size specified by the area information and thus generating a prompt for issuing an instruction for generation of the second object when the object information about the first object is not included in the acquired information and the area information is included in the acquired information.

5. The control method according to claim 1 further comprising:
receiving, from the server, the second object generated based on the prompt in the server; and
outputting the received second object to the application.

6. The control method according to claim 5 further comprising:
performing control to output the second object to an area specified by the area information in the operation screen of the application when the area information is included in the acquired information and the generated prompt is a prompt for issuing an instruction for generation of the second object based on a size specified by the area information.

7. The control method according to claim 5 further comprising:
performing control to output the second object to a predetermined position in the operation screen of the application or an artificial intelligence (AI) assistant operation screen of the application when the area information is not included in the acquired information.

8. The control method according to claim 1 further comprising:
generating a message indicating an operation which the user ought to perform next, based on the acquired information; and
performing control to output the generated message to an artificial intelligence (AI) assistant operation screen of the application,
wherein the message to be generated varies depending on whether the acquired information includes both the object information about the first object and the area information, whether the acquired information includes the object information about the first object and does not include the area information, and whether the acquired information does not include the object information about the first object and includes the area information.

9. An information processing apparatus which executes an add-in program, which is added in an application, the information processing apparatus comprising:
at least one memory that stores the add-in program; and
at least one processor that executes the add-in program to perform operations comprising:
acquiring information representing at least one of object information about a first object selected by a user in an operation screen of the application and area information about an area selected by the user in the operation screen of the application;
acquiring an operation request input by the user;
generating a prompt for causing generation of a second object based on the acquired information and the acquired operation request; and
transmitting the generated prompt to a server which generates the second object.

10. A non-transitory computer readable storage medium storing an add-in program, which is added in an application, that, when executed by a computer, causes the computer to perform a control method for an information processing apparatus, the control method comprising:
acquiring information representing at least one of object information about a first object selected by a user in an operation screen of the application and area information about an area selected by the user in the operation screen of the application;
acquiring an operation request input by the user;
generating a prompt for causing generation of a second object based on the acquired information and the acquired operation request; and
transmitting the generated prompt to a server which generates the second object.
